(19) United States
(12) Patent Application Publication
(10) Pub. No.: US 2009/0200877 A1
(43) Pub. Date: Aug. 13, 2009

(54) STEPPING MOTOR

(76) Inventors: Yoshiaki Koshida, Nagano (JP); Toshio Yamamoto, Nagano (JP); Takeyoshi Miyashita, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/630,628

(22) PCT Filed: Jun. 22, 2005
(86) PCT No.: PCT/JP2005/011426

§ 371 Date: Mar. 2, 2009

(30) Foreign Application Priority Data
Jun. 22, 2004 (JP) 2004-184204

(51) Int. Cl. H02K 37/14

(52) U.S. Cl. 310/49.32

(57) ABSTRACT

A stepping motor is provided with a rotor having with a rotor shaft A permanent magnet is attached to an outer peripheral side of the rotor shaft and a stator having pole teeth faces the permanent magnet in a radial direction. The stepping motor is characterized in that the rotor shaft is formed of aluminum or aluminum alloy.

### CROSS-REFERENCE TO RELATED APPLICATIONS

This application claims priority to PCT Application PCT/JP2005/011426 filed Jun. 22, 2004, which is incorporated herein by reference.

### FIELD OF THE INVENTION

The present invention relates to a small stepping motor and a lead screw part which is formed on an output side of its rotor shaft.

### BACKGROUND OF THE INVENTION

As a motor for moving an object to be moved at a high speed such as an optical head device used in a CD/DVD player or the like or a lens group used in a video camera, a stepping motor has been known which is provided with a rotor, which includes a rotor shaft and a permanent magnet attached to an outer periphery of the rotor shaft, and a stator having pole teeth which face the permanent magnet in a radial direction. In this type of a stepping motor, for example, an output shaft protruding from the stator is provided on the output side of the rotor shaft and a lead screw part is formed on the output shaft. The lead screw part threadedly engages with an object to be moved such as an optical head device to move the object at a high speed.

In recent years, since reduction of size and height has been required for a CD/DVD player, a video camera or the like, miniaturization of an object to be moved such as an optical head device has been strongly required and, as a result, miniaturization of a stepping motor has been also strongly required.

For example, in a small stepping motor, miniaturization is obtained by means of that a rotor shaft is provided separately from an output shaft where a lead screw part is formed to cause the rotor shaft to form in a small diameter (see Japanese Patent Laid-Open No. Hei 7-241065).

Further, a stepping motor has been also known in which an output shaft where a lead screw part is formed is made of aluminum alloy (see Japanese Patent Laid-Open No. Hei 5-88066).

However, in the stepping motor described in Japanese Patent Laid-Open No. Hei 7-241065, since stainless steel is used as material for the rotor shaft, weight of the rotor shaft is not remarkably reduced even when the rotor shaft is formed in a small diameter in order to obtain miniaturization and thus the inertial load of the rotor is not reduced. Therefore, it is difficult to secure motor characteristics such as a starting performance and a response performance, for example, in the case of a CD/DVD player, it takes a lot of time to read data from a disk.

Further, when the size of a stepping motor is reduced, its generated torque is also decreased and thus an inertia of the lead screw part which has not been conventionally required to be considered too much significantly affects characteristics of the stepping motor, especially the maximum self-activation frequency.

In other words, the maximum self-activation frequency S2 of a stepping motor provided with a lead screw part is expressed in the following expression when the maximum self-activation frequency of a stepping motor without a lead screw part is S1, the inertia of the lead screw part is I2, and the inertia of the rotor except the lead screw part is I1.

S2=S1/(1+I2/I2)^{1/2}

Therefore, as the ratio (I2/I1) between the inertia I2 of the lead screw part and the inertia I1 of the rotor except the lead screw part is increased, the maximum self-activation frequency S2 decreases in comparison with the maximum self-activation frequency S1 of a stepping motor which is not provided with the lead screw part and thus characteristics of the stepping motor deteriorate. As the diameter of the stepping motor decreases, the value of the (I2/I1) is increased and thus the motor characteristic deteriorates.

Therefore, in a miniaturized stepping motor, the inertia of a lead screw part is required to be restrained small to secure motor characteristics. As a means for causing the inertia of the lead screw part to be restrained small, as described in the Japanese Patent Laid-Open No. Hei 5-88066, a structure may be employed in which an output shaft where the lead screw part is formed is formed of aluminum alloy whose specific gravity is smaller than that of stainless steel.

In the above-mentioned Japanese Patent Laid-Open No. Hei 5-88066, a structure is disclosed in which aluminum alloy is used for the output shaft where a lead screw part is formed. However, in the case that the outer diameter of the lead screw part is made smaller to the extent of, for example, 4 mm or less, and in addition, in the case that the entire stepping motor is miniaturized, a specific structure of a stepping motor for preventing the maximum self-activation frequency from lowering and for securing a specified motor characteristic is not disclosed.

Therefore, an object of the present invention is to provide a structure which is capable of reducing its size and improving a motor characteristic in a small stepping motor.

Further, an object of the present invention is, in a small stepping motor, to provide a structure which is capable of preventing the maximum self-activation frequency from lowering and improving a motor characteristic even when an output shaft where a lead screw part is formed is provided.

### SUMMARY OF THE INVENTION

In order to attain the object described above, the present invention according to an exemplary embodiment of the present invention is characterized in that, in a stepping motor which is provided with a rotor having a rotor shaft and a permanent magnet attached to an outer peripheral side of the rotor shaft and a stator having pole teeth facing the permanent magnet in a radial direction, the rotor shaft is formed of aluminum or aluminum alloy.

In accordance with the present invention, even when the entire stepping motor is miniaturized, since aluminum or aluminum alloy whose specific gravity is smaller than that of stainless steel is utilized for the rotor shaft. Therefore, the weight of the rotor shaft is reduced and thus the inertial load of the rotor having the rotor shaft and the permanent magnet is reduced to improve a specified motor characteristic.

Since a stepping motor repeats starting and stopping by a specified angle each time pulse frequency is applied, the rotor is required to be quickly started and stopped in response to the pulse frequency. In accordance with the present invention, aluminum or aluminum alloy is employed for the rotor shaft and thus the weight of the rotor is reduced. Accordingly, following property of the rotor to pulse frequency is enhanced. In other words, starting performance and response performance of the motor can be improved.

In addition, heat conduction property of aluminum or aluminum alloy is superior in comparison with that of a conventional stainless steel. Therefore, when aluminum or aluminum alloy is utilized for the rotor shaft, heat generated in the inside of the motor accompanied with driving the motor can be efficiently radiated outside of the main body of the motor through the rotor shaft. Accordingly, a problem such that heat is accumulated in the inside of the main body of the motor to cause performance deterioration of the permanent magnet due to the heat or damage of the insulating layer of a coil winding can be eliminated without modifying a structure of the main body of the motor for the countermeasure of heat or without attaching a new component.

In the present invention, it is preferable that an output shaft protruding from the stator is provided on the output side of the rotor shaft and the output shaft is formed of aluminum or aluminum alloy and a lead screw part is formed on the output shaft.

According to the structure as described above, since the weight of the output shaft where the lead screw part is formed is reduced even when the diameter of the lead screw part is set to be smaller, lowering of the maximum self-activation frequency of a stepping motor is prevented and starting performance and response performance can be improved and further, a starting torque can be improved.

In addition, a surface area of the output shaft can be further widely secured by means of that the lead screw part is formed on the output shaft. Therefore, heat generated in the inside of the motor accompanied with driving of the motor is transmitted to the output shaft from the rotor shaft to be efficiently radiated outside of the main body of the motor.

Further, the present inventors have executed various examinations to solve the above-mentioned problem. As a result, the present inventors have found that, even when the outer diameter of a lead screw part is set to be smaller, for example, to the extent of 4 mm or less, and in addition, even when the size of the entire stepping motor is reduced, in the case that the outer diameter of the permanent magnet and the outer diameter of the lead screw part which structure a rotor satisfy a certain relationship, the lowering of the maximum self-activation frequency is prevented more effectively and starting performance and response performance can be further improved and a starting torque is further improved by means of that the output shaft where the lead screw part is formed is formed of aluminum or aluminum alloy.

The present invention is based on the above-mentioned new finding and it is preferable that, when the outer diameter of the lead screw part is set to be “D1” and the outer diameter of the permanent magnet is set to be “D2”, the following relationship is satisfied.

D1≦4 (mm) and D2≦D1+5 (mm)

According to the structure as described above, even when the diameter of the lead screw part is set to be smaller and the entire stepping motor is miniaturized, the lowering of the maximum self-activation frequency is prevented more effectively and starting performance and response performance can be further improved and a starting torque is further improved because the weight of the output shaft where the lead screw part is formed is reduced.

In accordance with the present invention, it is preferable that an adhesive retaining portion formed on the rotor shaft or the lead screw part is formed by rolling process. According to the structure as described above, since the surface of the adhesive retaining portion formed on the rotor shaft or the lead screw part by the rolling process is hardened, its rigidity is increased. Therefore, even when the adhesive retaining portion or the lead screw part is formed with a small diameter or even when aluminum or aluminum alloy whose rigidity is smaller than that of stainless steel is employed as material of the rotor shaft forming the adhesive retaining portion or as material of the output shaft forming the lead screw part, the adhesive retaining portion or the lead screw part which is hard to be bent and easy to be utilized can be formed.

In accordance with the present invention, it is preferable that an aluminum anodic oxidation (alumite) treatment or a chromate treatment is performed on the adhesive retaining portion formed on the rotor shaft or the lead screw part. As an aluminum anodic oxidation (alumite) treatment, it is preferable that, for example, a colorless alumite treatment or a hard alumite treatment is performed and, as a chromate treatment, it is preferable that, for example, an allogine treatment (chromic acid conversion treatment) is performed. Occurrence of corrosion in the adhesive retaining portion and the lead screw part can be prevented and abrasion resistance is also further improved by means of that an aluminum anode oxidation (alumite) treatment or a chromate treatment is performed in the adhesive retaining portion and the lead screw part which is formed of aluminum or aluminum alloy.

According to the present invention, in a stepping motor which is provided with a rotor having a rotor shaft and a permanent magnet attached to an outer peripheral side of the rotor shaft and a stator having pole teeth facing the permanent magnet in a radial direction, the rotor shaft is formed of aluminum or aluminum alloy. Therefore, since the weight of the rotor is reduced, the inertial load of the rotor can be reduced. As a result, a specified motor characteristic can be improved.

Further, according to the present invention, an output shaft where a lead screw part is formed is formed of aluminum or aluminum alloy, and it is structured that an outer diameter “D1” of the lead screw part and an outer diameter “D2” of a permanent magnet satisfy a certain relationship. Therefore, even when the diameter of the lead screw part is set to be smaller and the stepping motor is miniaturized, lowering of the maximum self-activation frequency can be prevented more effectively. As a result, a specified motor characteristic can be improved.

### BRIEF DESCRIPTION OF DRAWINGS

FIG. 1 is a side cross-sectional view showing a stepping motor in accordance with an embodiment of the present invention.

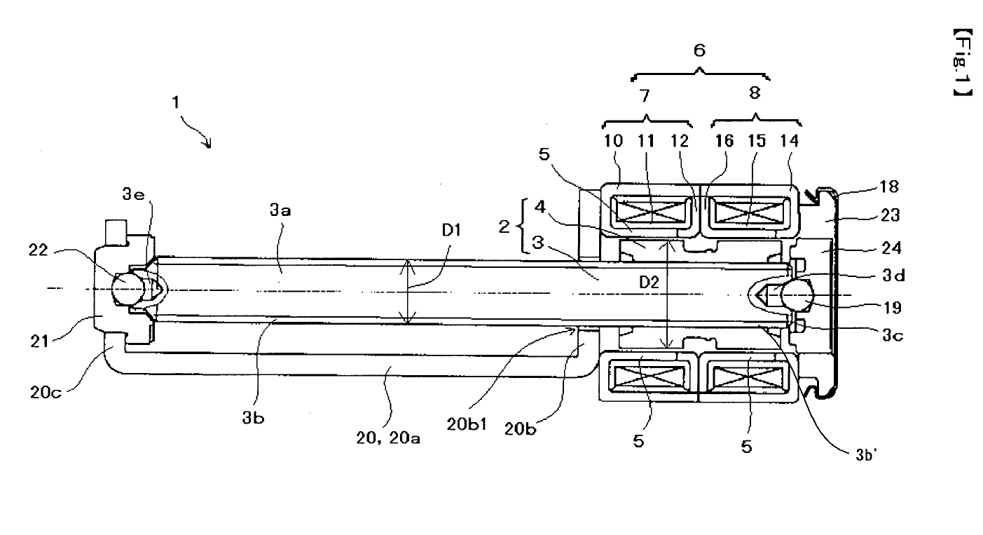

FIG. 2: (A) and (B) are respectively a graph showing a relationship between an increasing rate of the maximum self-activation frequency when the material of the output shaft on which the lead screw part is formed is changed to aluminum alloy from stainless steel in the case that the outer diameter of the lead screw part is set to be 2 mm and an outer diameter of the permanent magnet, and a table showing structural conditions of the rotor.

FIG. 3: (A) and (B) are respectively a graph showing a relationship between an increasing rate of the maximum self-activation frequency when the material of the output shaft on which the lead screw part is formed is changed to aluminum alloy from stainless steel in the case that the outer diameter of the lead screw part is set to be 3 mm and an outer diameter of the permanent magnet, and a table showing structural conditions of the rotor.

FIG. 4: (A) and (B) are respectively a graph showing a relationship between an increasing rate of the maximum self-activation frequency when the material of the output shaft on which the lead screw part is formed is changed to aluminum alloy from stainless steel in the case that the outer diameter of the lead screw part is set to be 4 mm and an outer diameter of the permanent magnet, and a table showing structural conditions of the rotor.

FIG. 5: a side cross-sectional view showing a stepping motor in accordance with another embodiment of the present invention.

### DETAILED DESCRIPTION OF THE INVENTION

A stepping motor 1 in accordance with this embodiment is a so-called PM type of stepping motor, which includes a rotor 2 having a rotor shaft 3 and a cylindrical permanent magnet 4, a stator 6 having pole teeth 5 facing the permanent magnet 4 in a radial direction, and a frame 20 attached to a stator 6 on an output side of the rotor shaft 3. In addition, an output shaft 3a is integrally formed on the output side of the rotor shaft 3 so as to protrude from the stator 6. A lead screw part 3b is formed on the output shaft 3a. Further, a bearing hold member 23 is attached on an opposite output side of the stator 6 (base end 3c side of the rotor shaft 3) and a bearing 24 is held to the bearing hold member 23.

The rotor shaft 3 is formed of aluminum or aluminum alloy which is a nonmagnetic material, and a cylindrical permanent magnet 4 is fixed to its outer circumferential face by using an adhesive or the like. In this embodiment, an adhesive retaining portion 3b′ is formed at a portion of the rotor shaft 3 where the permanent magnet 4 is fixed. In addition, the lead screw part 3b formed on the output shaft 3a is also used as the adhesive retaining portion 3b′. In other words, the adhesive retaining portion 3b′ is formed of a spiral groove between thread ridges.

Since the adhesive retaining portion 3b′ is formed in a spiral shape, the adhesive can be stably coated on a portion where the permanent magnet 4 is fixed in both the circumferential direction and the axial direction. Thus, adhesive strength to the permanent magnet 4 is enhanced and extra adhesive does not leak out.

Further, the adhesive retaining portion 3b′ formed on the rotor shaft 3 is formed by rolling process and, in addition, an aluminum anodic oxidation (alumite) treatment or a chromate treatment is performed in the adhesive retaining portion 3b′. As an aluminum anodic oxidation (alumite) treatment, for example, a colorless alumite treatment or a hard alumite treatment is performed and, as a chromate treatment, for example, an allogine treatment (chromic acid conversion treatment) is performed. As described above, the adhesive retaining portion 3b′ is provided with corrosion resistance to be in a chemically stabilized state by performing the surface treatment and thus reaction of an adhesive is stably performed and adhesive strength to the permanent magnet 4 is further enhanced.

In this embodiment, the permanent magnet 4 is a rare-earth permanent magnet whose material is neodymium or the like and which is formed by injection molding or compression molding. The permanent magnet 4 is well known and thus its detailed description is omitted.

Further, in this embodiment, a sleeve may be interposed between the rotor shaft 3 and the permanent magnet 4. The material of the sleeve is aluminum, aluminum alloy, synthetic resin or the like. The weight of the sleeve is lesser than that of the permanent magnet 4 and thus light-weighting and reduction of inertia of the rotor are obtained and its cost is reduced.

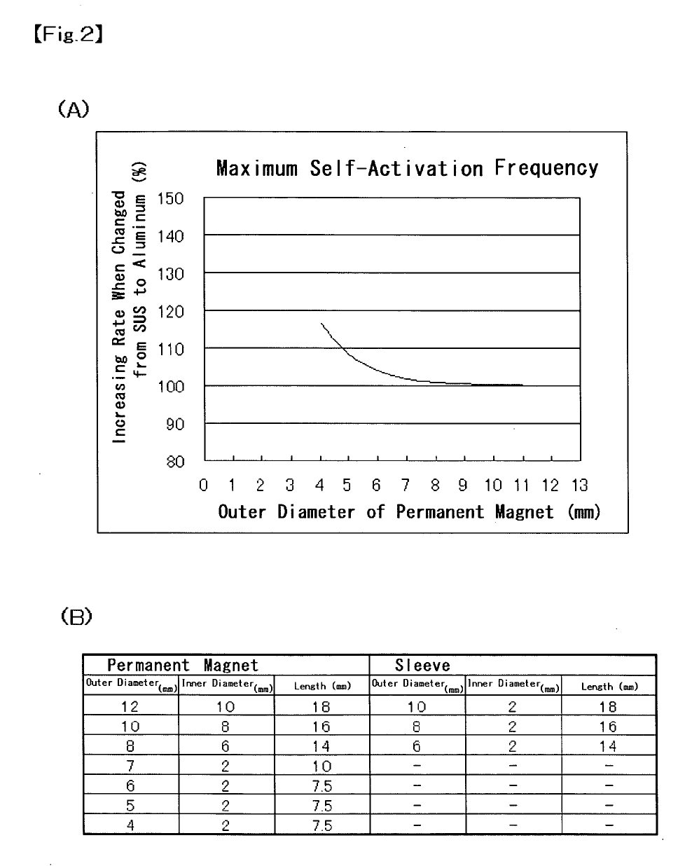

For example, in the examples shown in FIGS. 2 through 4 described below, in the case that the outer diameter of the permanent magnet is 8 mm or more, in other words, in the case that its thickness is 2.5 mm or more, the sleeve is interposed because a magnetic force is hardly increased even when the thickness of the permanent magnet is increased. In this case, the thickness of the permanent magnet when the sleeve is interposed is not limited to this embodiment, and a magnetic force of the permanent magnet and the weight of the rotor are taken into consideration to determine whether the sleeve is interposed or not.

The output shaft 3a on which the lead screw part 3b is formed is formed to protrude from the stator 6 and its material is aluminum or aluminum alloy which is nonmagnetic material. As described above, since the output shaft 3a is formed of nonmagnetic material, leakage flux from the motor is not easily generated and thus a problem is not occurred in an object to be moved such as an optical head device of a CD/DVD player.

The lead screw part 3b is formed on the outer circumferential face of the output shaft 3a by rolling process and an aluminum anodic oxidation (alumite) treatment or a chromate treatment is performed in the lead screw part 3b. As the aluminum anodic oxidation (alumite) treatment, for example, a colorless alumite treatment or a hard alumite treatment is performed and, as a chromate treatment, for example, an allogine treatment is performed. The lead screw part 3b threadedly engages with an object to be moved such as an optical head device of a CD/DVD player to move the object.

The lead screw part 3b in this embodiment is formed such that, in order to move a small object to be moved, when its outer diameter is set to be “D1”, “D1” satisfies: D1≦4 (mm)

Further, the lead screw part 3b and the permanent magnet 4 are formed to satisfy a certain relationship. More specifically, when an outer diameter of the permanent magnet 4 is set to be “D2”, the lead screw part 3b and the permanent magnet 4 are formed to satisfy the following relationship:

D2≦D1+5 (mm)

For example, the outer diameter “D1” of the lead screw part 3b is 3 mm and the outer diameter D2 of the permanent magnet 4 is 6 mm. In this embodiment, the outer diameter “D1” of the lead screw part 3b corresponds to the outer diameter of the output shaft 3a.

A recessed part 3d into which a part of a spherical pivot 19 is inserted is formed at a base end 3c of the rotor shaft 3 in an axial direction. On the other hand, a recessed part 3e into which a part of a spherical pivot 22 is inserted is formed at an output side end of the output shaft 3a in the axial direction.

The stator 6 is structured of a first stator assembly 7 and a second stator assembly 8 and these stator assemblies 7 and 8 are disposed to overlap each other in the axial direction. The first stator assembly 7 is comprised of a first outer stator core 10, a first bobbin 11 around which a coil is wound, and a first inner stator core 12 which sandwiches the first bobbin 11 with the first outer stator core 10 and is located on the output side of the rotor shaft 3. A plurality of pole teeth 5 which is formed in each of the first outer stator core 10 and the first inner stator core 12 is disposed so as to be adjacent in a circumferential direction on the inner peripheral side of the first bobbin 11.

The second stator assembly 8 is comprised of a second outer stator core 14, a second bobbin 15 around which a coil is wound, and a second inner stator core 16 which sandwiches the second bobbin 15 with the second outer stator core 14 and is located on the opposite output side of the rotor shaft 3. A plurality of pole teeth 5 which is formed in each of the second outer stator core 14 and the second inner stator core 16 is disposed so as to be adjacent in a circumferential direction on the inner peripheral side of the second bobbin 15.

A frame 20 attached to the stator 6 on the output side of the rotor shaft 3 is a metal frame which is formed by using a metal plate such as a stainless-steel plate and is formed in a U-shape that is provided with a bottom face part 20a and side face parts 20b and 20c. The side face part 20b is located on the opposite output side and the frame 20 is attached to the stator 6 by means of that the side face part 20b is fixed to the first outer stator core 10 which structures the stator 6. Further, a penetrating hole 20b1 into which the rotor shaft 3 and the output shaft 3a are loosely inserted is formed in the side face part 20b. The side face part 20c is located on the output side and a bearing 21 made of resin which is provided with a recessed part into which a part of the pivot 22 is inserted is fixed. The output side end of the rotor 2 is supported by the bearing 21 and the pivot 22 in the radial direction and the thrust direction.

A bearing hold member 23 which is attached on the opposite output side of the stator 6 (base end 3c side of the rotor shaft 3) is a circular ring shaped member. A bearing 24 made of resin which is provided with a recessed part into which a part of the pivot 19 is inserted is held on the inner circumferential side of the bearing hold member 23. Further, an end plate 18 which is formed by using a thin metal plate such as a stainless-steel plate is attached to an end face on the opposite output side of the bearing hold member 23. A flat spring portion (not shown) which is formed by cutting and being bent is formed at a center portion of the end plate 18. The flat spring part urges the rotor shaft 3 on the output side through the bearing 24 and the pivot 19. The opposite output side end of the rotor 2 is supported by the flat spring portion, the bearing 24 and the pivot 19 in the radial direction and the thrust direction.

As described above, in the stepping motor 1 in accordance with this embodiment, since the rotor shaft 3 is formed of aluminum or aluminum alloy, weight of the rotor 2 having the rotor shaft 3 and the permanent magnet 4 is reduced. Therefore, inertial load of the rotor 2 can be reduced. As a result, motor characteristics of the stepping motor 1, especially, starting performance and response performance can be improved.

Further, since aluminum or aluminum alloy is nonmagnetic material, leakage of magnetic flux is not easily generated to the outside of the main body of the motor and a problem is not induced in other magnetic members and the like.

In addition, the adhesive retaining portion (lead screw part) 3b formed in a spiral shape is formed on the rotor shaft 3 and thus an adhesive can be stably coated at a portion where the permanent magnet 4 is fixed in both the circumferential direction and the axial direction. Thus, adhesive strength to the permanent magnet 4 is enhanced and extra adhesive does not leak out.

Further, the adhesive retaining portion 3b′ formed on the rotor shaft 3 is formed by rolling process and an aluminum anodic oxidation (alumite) treatment or a chromate treatment is performed on the adhesive retaining portion 3b′. As described above, the adhesive retaining portion 3b′ is provided with corrosion resistance to be in a chemically stabilized state by performing the surface treatment and thus reaction of the adhesive is stably performed and adhesive strength to the permanent magnet 4 is further enhanced. In addition, since the surface of the adhesive retaining portion 3b′ is hardened as the rolling process is performed, rigidity of the rotor shaft 3 can be enhanced.

Further, the stepping motor 1 in accordance with this embodiment is structured such that the output shaft 3a on which the lead screw part 3b is formed is formed of aluminum or aluminum alloy and that the outer diameter “D1” of the lead screw part 3b and the outer diameter “D2” of the permanent magnet satisfies the following relationship:

D1≦4 (mm) and D2≦D1+5 (mm)

According to the structure of the stepping motor 1 as described above, even when the diameter of the lead screw part 3b is set to be smaller and the stepping motor 1 is miniaturized, the lowering of the maximum self-activation frequency can be prevented more effectively by forming the output shaft 3a with aluminum or aluminum alloy. Next, this effect in this embodiment will be described below in detail with reference to FIGS. 2 through 4.

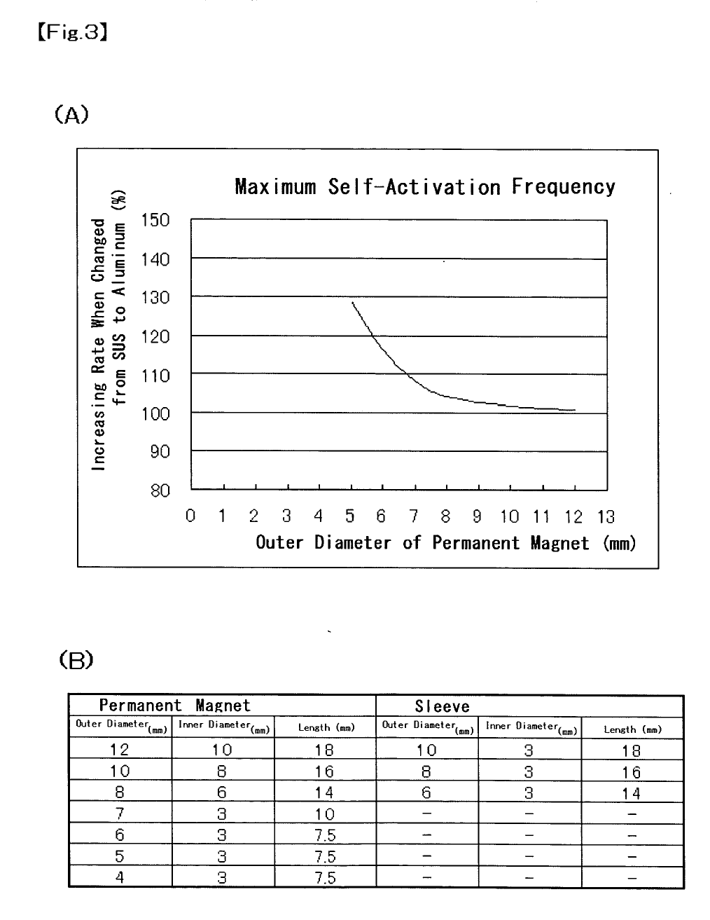

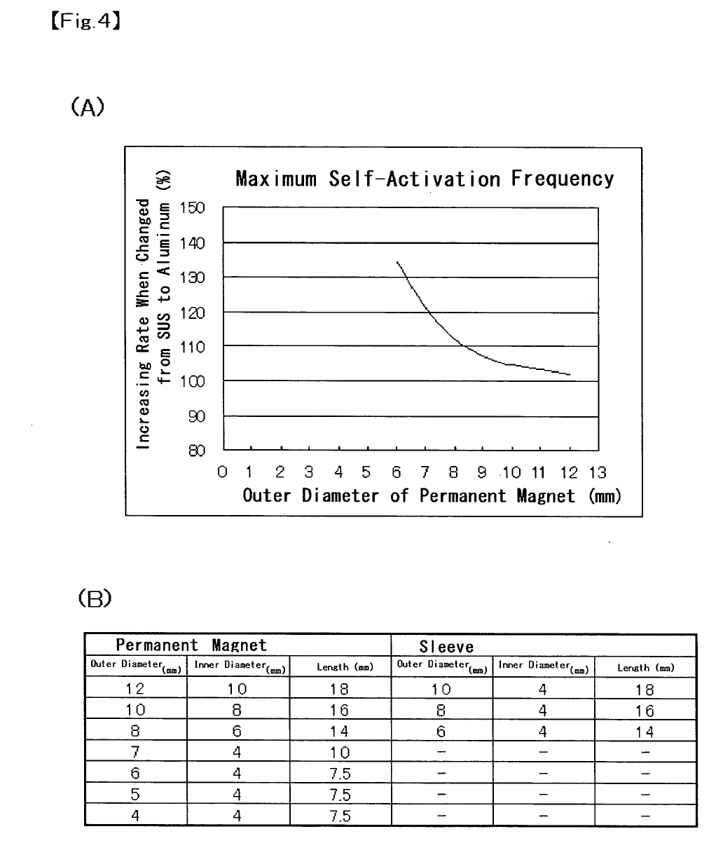

FIGS. 2(A) and 2(B) are respectively a graph showing a relationship between an increasing rate of the maximum self-activation frequency when the material of the output shaft 3a on which the lead screw part is formed is changed to aluminum alloy from stainless steel and an outer diameter of the permanent magnet when the outer diameter of the lead screw part is set to be 2 mm, and a table showing structural conditions of the rotor. FIGS. 3(A) and 3(B) are respectively a graph showing a relationship between an increasing rate of the maximum self-activation frequency when the material of the output shaft 3a on which the lead screw part is formed is changed to aluminum alloy from stainless steel and an outer diameter of the permanent magnet in the case that the outer diameter of the lead screw part is set to be 3 mm, and a table showing structural conditions of the rotor. FIGS. 4(A) and 4(B) are respectively a graph showing a relationship between an increasing rate of the maximum self-activation frequency when the material of the output shaft 3a on which the lead screw part is formed is changed to aluminum alloy from stainless steel and an outer diameter of the permanent magnet in the case that the outer diameter of the lead screw part is 4 mm, and a table showing structural conditions of the rotor.

As shown in FIG. 2(A), in the case that the outer diameter “D1” of the lead screw part 3b is set to be 2 mm, when the outer diameter “D2” of the permanent magnet 4 is gradually decreased from 12 mm to 7 mm, the maximum self-activation frequency is hardly changed even when the material of the output shaft 3a is changed from stainless steel to aluminum alloy in this embodiment. On the other hand, when the outer diameter “D2” of the permanent magnet 4 is decreased from 7 mm, an increasing rate of the maximum self-activation frequency increases when the material of the output shaft 3a is changed from stainless steel to aluminum alloy. In this case, the structure of the rotor 2 in respective outer diameters “D2” of the permanent magnet 4 is set as shown in FIG. 2(B) in consideration of a general stepping motor which is provided with the lead screw part 3b.

A sleeve described in FIG. 2(B) is a cylindrical member which is disposed between the rotor shaft 3 and the permanent magnet 4 when the outer diameter “D2” of the permanent magnet 4 is comparatively large. Therefore, an outer diameter of the sleeve is substantially the same as an inner diameter of the permanent magnet 4 and its inner diameter is substantially the same as an outer diameter of the rotor shaft 3. Further, a specific gravity of the permanent magnet 4 is 5.8 (g/cm³) and a specific gravity of the sleeve is 3 (g/cm³). A length of the rotor shaft 3 and the output shaft 3a which is integrally formed therewith is 57 mm. These are the same as cases where the outer diameters “D1” of the lead screw part 3b are set to be 3 mm and 4 mm as described below.

As shown in FIG. 3(A), in the case that the outer diameter “D1” of the lead screw part 3b is set to be 3 mm, when the outer diameter “D2” of the permanent magnet 4 is gradually decreased from 12 mm to 8 mm, an increasing rate of the maximum self-activation frequency increases a little even when the material of the output shaft 3a is changed from stainless steel to aluminum alloy. On the other hand, when the outer diameter “D2” of the permanent magnet 4 is decreased from 8 mm, the increasing rate of the maximum self-activation frequency increases largely when the material of the output shaft 3a is changed from stainless steel to aluminum alloy. Also in this case, the structure of the rotor 2 is set as shown in FIG. 3(B) in consideration of a general stepping motor which is provided with the lead screw part 3b.

Further, as shown in FIG. 4(A), in the case that the outer diameter “D1” of the lead screw part 3b is set to be 4 mm, when the outer diameter “D2” of the permanent magnet 4 is gradually decreased from 12 mm to 9 mm, an increasing rate of the maximum self-activation frequency increases a little even when the material of the output shaft 3a is changed from stainless steel to aluminum alloy. On the other hand, when the outer diameter “D2” of the permanent magnet 4 is decreased from 9 mm, the increasing rate of the maximum self-activation frequency increases largely when the material of the output shaft 3a is changed from stainless steel to aluminum alloy. Also in this case, the structure of the rotor 2 is set as shown in FIG. 4(B) in consideration of a general stepping motor which is provided with the lead screw part 3b.

As described above, in the case that the outer diameter “D1” of the lead screw part 3b is set to be 4 mm or less, when the outer diameter “D2” of the permanent magnet 4 is formed to satisfy the following relationship:

D2≦D1+5 (mm),

it is confirmed that the increasing rate of the maximum self-activation frequency can be increased largely by using aluminum alloy as the material of the output shaft 3a on which the lead screw part 3b is formed in comparison with the case that the output shaft 3a is formed of stainless steel. In other words, in the case that the outer diameter “D1” of the lead screw part 3b is set to be 4 mm or less, when the outer diameter “D2” of the permanent magnet 4 is formed to satisfy the following relationship:

D2>D1+5 (mm),

it is confirmed that lowering of the maximum self-activation frequency cannot be prevented effectively even when aluminum alloy is used as the material of the output shaft 3a on which the lead screw part 3b is formed. Therefore, when the outer diameter “D1” of the lead screw part 3b is set to be 4 mm or less, the outer diameter “D2” of the permanent magnet 4 is formed to satisfy the following relationship:

D2≦D1+5 (mm),

In this case, lowering of the maximum self-activation frequency of stepping motor 1 can be prevented more effectively by using aluminum alloy as the material of the output shaft 3a where the lead screw part 3b is formed and thus motor characteristic of the stepping motor 1 can be improved.

Further, in this embodiment, the lead screw part 3b is formed by rolling process. Therefore, the surface of the lead screw part 3b is hardened by the rolling process to increase rigidity of the lead screw part 3b. Accordingly, even when the outer diameter of the lead screw part 3b is set to be thinner like 4 mm or less, or even when aluminum or aluminum alloy is employed as material of the output shaft 3a, the lead screw part 3b which is hard to be bent and is easily used can be formed.

Further, in this embodiment, an aluminum anodic oxidation (alumite treatment) or a chromate treatment is performed on the lead screw part 3b. As described above, an aluminum anodic oxidation (alumite treatment) or a chromate treatment is performed on the lead screw part 3b formed of aluminum or aluminum alloy and thus occurrence of corrosion in the lead screw part 3b can be prevented and, in addition, abrasion resistance is improved.

The embodiment described above is an example of a preferred embodiment of the present invention. However, the present invention is not limited to the embodiment described above and many modifications can be made without departing from the present invention. For example, in the embodiment described above, the adhesive retaining portion 3b′ is formed on the rotor shaft 3 and the lead screw part 3b is formed on the output shaft 3a which is integrally formed with the rotor shaft 3. However, the lead screw part 3b may be formed only on the output shaft 3a without forming the adhesive retaining portion 3b′ on the rotor shaft 3. Further, an aluminum anodic oxidation (alumite) treatment or a chromate treatment may be performed on an outer circumferential face of the rotor shaft 3 on which the adhesive retaining portion 3b′ is not formed.

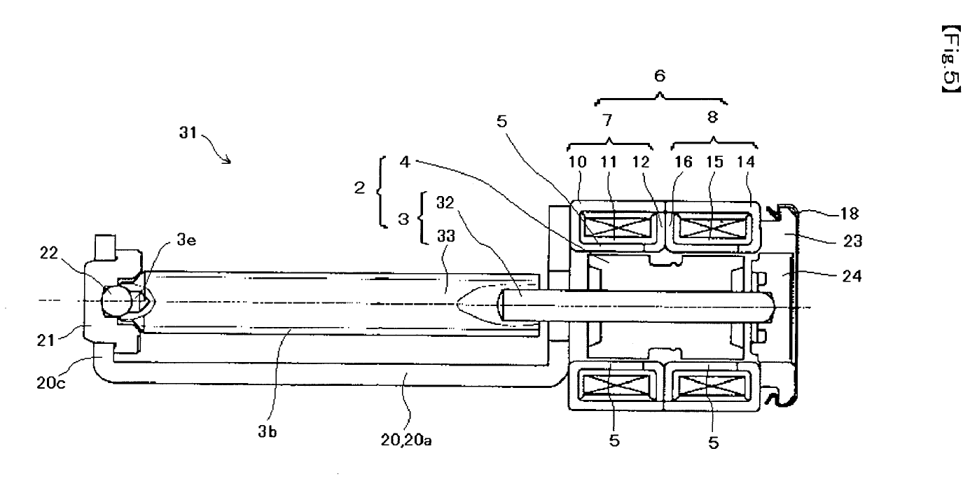

Further, as shown in FIG. 5, two members may be used in which the rotor shaft 3 is a small diameter portion 32 to which the permanent magnet 4 is fixed and which is made of aluminum or aluminum alloy and the output shaft 3a is a large diameter portion 33 on which the lead screw 3b is formed and which is made of aluminum or aluminum alloy.

The stepping motor 31 shown in FIG. 5 is provided with a similar structure to the above-mentioned embodiment except that the rotor shaft 3 and the output shaft 3a are structured with two members as described above and an end face of the small diameter portion 32 is formed in a hemispheric shape to structure a pivot instead of the pivot 19. Therefore, the same notational symbols are used to the same structural members.

In the present invention, since aluminum or aluminum alloy is employed for the rotor shaft of a stepping motor, the weight of the rotor shaft is reduced and the inertial load of the rotor having the rotor shaft and the permanent magnet is reduced.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

1. A stepping motor comprising:
a rotor having a rotor shaft;
a permanent magnet attached to an outer peripheral side of the rotor shaft; and
a stator having pole teeth facing the permanent magnet in a radial direction, wherein the stepping motor is characterized in that the rotor shaft is formed of aluminum or aluminum alloy.

2. The stepping motor according to claim 1, further comprising an output shaft protruding from the stator on the output side of the rotor shaft, wherein the output shaft is formed of aluminum or aluminum alloy and a lead screw part is formed on the output shaft.

3. The stepping motor according to claim 2, wherein when an outer diameter of the lead screw part is set to be “D1” and an outer diameter of the permanent magnet is set to be “D2”, a following relationship is satisfied:
D1≦4 (mm) and D2≦D1+5 (mm).

4. The stepping motor according to claim 1, wherein an adhesive retaining portion which is formed on the rotor shaft or the lead screw part is formed by rolling process.

5. The stepping motor according to claim 2, wherein an aluminum anodic oxidation (alumite) treatment or a chromate treatment is performed on an adhesive retaining portion which is formed on the rotor shaft or the lead screw part.

6. The stepping motor according to claim 1, wherein stator having a pole teeth faces the permanent magnet in a radial direction.
